(19) United States
(12) Patent Application Publication
(10) Pub. No.: US 2007/0069865 A1
(43) Pub. Date: Mar. 29, 2007

(54) IC tag, IC tag system, and data communicating method for the IC tag

(75) Inventors: Kazuhiro Akiyama, Kanagawa (JP); Hatsuhide Igarashi, Kanagawa (JP); Tetsuya Kawasaki, Kanagawa (JP); Seiichi Okamoto, Kanagawa (JP); Toshiyuki Miyashita, Kanagawa (JP); Kazumi Seki, Kanagawa (JP); Tatsuya Uchino, Kanagawa (JP); Yuichi Sakurai, Miyagi (JP); Tooru Miura, Miyagi (JP)

Correspondence Address: SUGHRUE MION, PLLC, 2100 PENNSYLVANIA AVENUE, N.W., SUITE 800, WASHINGTON, DC, 20037, US

(73) Assignees: NEC Electronics Corporation; NEC TOKIN Corporation

(21) Appl. No.: 11/528,380

(22) Filed: Sep. 28, 2006

(30) Foreign Application Priority Data
Sep. 29, 2005 (JP) 2005-283447

(51) Int. Cl. H04Q 5/22

(52) U.S. Cl. 340/10.2

(57) ABSTRACT

According to an embodiment of the invention, an IC tag for receiving a command data including a first command data not requiring the IC tag to send back response data and a second command data requiring the IC tag to send back the response data using a radio signal, including: a control circuit generating a confirmation signal indicating a reception condition of first command data; and a transmitter transmitting the confirmation signal.

### BACKGROUND OF THE INVENTION

1. Field of the Invention

The present invention relates to an IC tag, an IC tag system, and a data communication method for the IC tag. In particular, the present invention relates to a data transmitting method for retransmitting a command in the case where data communication ends in failure.

2. Description of Related Art

In recent years, attentions have been paid to a technique regarding RFID (Radio Frequency IDentification) in the fields of merchandise logistics management at the factory and article management at a retail shop. This technique affixes to a product a tag incorporating an IC having product specific information written thereto, and scans this information using a wireless antenna.

This technique uses a reader/writer and an RFID tag (hereinafter referred to as “IC tag”). The reader/writer sends command data to the IC tag using a modulated radio signal including data and carrier, and receives a radio signal from the IC tag. The IC tag demodulates the received radio signal to execute a processing based on the received command data. Further, if response data to the received data is required, the IC tag sends the response data to the reader/writer. The IC tag integrates, for example, an IC chip and an antenna.

Among the IC tags, a so-called passive IC tag receives a radio signal from the reader/writer to generate a power supply voltage for tag operations based on the radio signal. That is, in the passive IC tag, the radio signal for communications between the tag and the reader/writer is utilized for power supply and data transmission/reception.

In these series of operations, a rate at which the IC tag can correctly receive command data from the reader/writer largely varies depending on a distance between the reader/writer and the IC tag, a manufacturing tolerance of the IC tag (for example, variations in transistor threshold voltage Vth), properties of a product to which the IC tag is incorporated (for example, metals reflect a radio signal, and moisture absorbs a radio signal), and surrounding environments. FIG. 12 shows an example thereof. The IC tag is designed such that a success rate of 100% is attained at a communication distance of 30 cm between the reader/writer and the IC tag, for example.

In FIG. 12, a curve (a) represents a relation between a reception success rate and a communication distance in the case where the IC tag involves no variations. In FIG. 12, a curve (b) represents a relation between a reception success rate and a communication distance in the case where the IC tag involves the largest variations.

A curve (c) of FIG. 12 represents a relation between a reception success rate and a communication distance in the case where moisture contents around a product to which the IC tag is incorporated are high, metals exist around the product, or a wireless LAN that utilizes a carrier of a frequency close to a carrier of the reader/writer is provided near the product. If moisture contents around a product to which the IC tag is incorporated are high or metals exist around the product, the moisture absorbs a radio signal and the metals reflect the radio signal, which causes a problem in that a power supply voltage for operating the IC tag cannot be generated. Further, if there is a radio signal of the wireless LAN near the product, a carrier of the wireless LAN exists close to the carrier of the reader/writer, so the carrier of the wireless LAN interfere with the carrier for communications between the reader/writer and the IC tag, which causes a problem in that an error occurs in the command data.

A curve (d) of FIG. 12 represents a relation between a reception success rate and a communication distance in the case where a communication state of the reader/writer and the IC tag is unstable, for example, the case where a hand-held reader/writer is used, and thus a communication distance or a speed of the reader/writer relative to that of the IC tag is not constant, or the case where directivities of antennas are not matched.

As described above, a rate at which the IC tag succeeds in receiving a command from the reader/writer is decreased as indicated by the curves (c) and (d) in some use environments. In conventional techniques, if the IC tag fails in receiving data, the reader/writer retransmits the command data to compensate for the reception failure. The retransmission of the command data is described below.

The case in which the command data is successfully received is described first. FIG. 13 shows a processing flow in the case where the reception of the command data is completed. As shown in FIG. 13, the reader/writer sends four command data C1 to C4. After receiving each command data, the IC tag executes commands of the data with its internal circuit. To mention the command data C1 to C4, C1 is an INIT command to initialize the IC tag, C2 is a WAKE command to bring the IC tag into an operating state, C3 is an ADR_SET command to designate an address of a memory of the IC tag, and C4 is a Read command to read information stored in the memory at an address designated by the command data C3, for example. The command data C1 to C3 do not require the IC tag to send response data back to the reader/writer. After the IC tag executes command of these command data, the execution result is not transmitted. The command data C4 is a command to read memory information, so the read memory information is sent to the reader/writer as the response data.

If the IC tag succeeds in receiving the command data, the reader/writer receives the response data from the IC tag to thereby confirm that the command data is successfully received. In contrast, FIG. 14 shows a processing flow in the case where the C tag fails in receiving the command data, and the reader/writer retransmits the command data. The processing flow of FIG. 14 is a flow in such a case where, upon sequentially receiving the command data C1 to C4, the IC tag fails in receiving the command data C3, and cannot send back the response data after receiving the command data C4. In this case, the reader/writer waits for the response data for a predetermined period, and then retransmits the command data C1 to C4 if not receiving the response data.

As described above, the reader/writer determines whether or not the IC tag can correctly receive the command data C1 to C4, based on the response data from the IC tag. Further, if the IC tag fails in receiving the command data, the reader/writer repeatedly retransmits all command data that require response data until receiving the response data.

That is, in conventional systems using a radio signal, the reader/writer determines whether or not the IC tag succeeds in receiving command data, based on the processing result of command data that requires response data. Further, Japanese Unexamined Patent Application No. 3-62290 discloses a technique of sending, if command data communication ends in failure as in the above cases, a notification to that effect toward the IC tag from the reader/writer.

However, in the conventional systems using a radio signal, if plural related command data are transmitted, and transmission of any one of the command data ends in failure, all the command data are retransmitted. Hence, there arises a problem in that a period necessary for retransmission in the case where the command data communication ends in failure increases, and in some cases, requisite communications cannot be completed.

For example, there is an example of executing data communication with an IC tag put on a product while transferring the product on a conveyor belt. In this case, the IC tag is moved at the moving speed of the conveyor belt, so the reader/writer should communicate with the IC tag with in a limited period. Under such circumstances, if it takes much time to retransmit a command when a communication error of the command occurs, data communications cannot be completed within a limited period in some cases. This problem would be more serious in such a case where the conveyor belt moves at higher speed to process more products.

### SUMMARY OF THE INVENTION

According to an aspect of the invention, an IC tag for receiving a command data including a first command data not requiring the IC tag to send back response data and a second command data requiring the IC tag to send back the response data using a radio signal, including: a control circuit generating a confirmation signal indicating a reception condition of first command data; and a transmitter transmitting the confirmation signal.

According to the IC tag of the present invention, even if the IC tag fails in receiving the first command data not requiring the response data, the reader/writer can conclude that the IC tag fails in receiving the first command data from the fact that no confirmation signal is sent back. Hence, the reader/writer can retransmit the first command data which the IC tag could not correctly receive. Thus, even in the case of transmitting plural first command data and then reading information stored in the IC tag in accordance with the second command data, the reader/writer retransmits the first command data that caused a communication error, making it possible to reduce a period for retransmitting command data in such a case where the first command data and the second command data are successively transmitted, and the IC tag fails in receiving the command data, as compared with a conventional example of transmitting all of the first and second command data.

### BRIEF DESCRIPTION OF THE DRAWINGS

The above and other objects, advantages and features of the present invention will be more apparent from the following description taken in conjunction with the accompanying drawings, in which:

FIG. 1 is a block diagram of an IC tag system according to a first embodiment of the present invention;

FIG. 2 is a block diagram of an IC tag of the first embodiment;

FIG. 3 shows signals used in the IC tag system of the first embodiment;

FIG. 4A is a flowchart of a processing flow of one passive command data in the IC tag system of the first embodiment;

FIG. 4B is a flowchart of a processing flow of one active command data in the IC tag system of the first embodiment;

FIG. 5A is a flowchart of a processing flow in the case where a processing of plural command data succeeds in the IC tag system of the first embodiment;

FIG. 5B is a flowchart of a processing flow in the case where a processing of plural command data ends in failure in the IC tag system of the first embodiment;

FIG. 6 is a block diagram of an IC tag according to a second embodiment of the present invention;

FIG. 7A is a flowchart of a processing flow in the case where a processing of plural command data succeeds in an IC tag system of the second embodiment;

FIG. 7B is a flowchart of a processing flow in the case where a processing of plural command data ends in failure in the IC tag system of the first embodiment;

FIG. 8 is a block diagram of an IC tag according to a third embodiment of the present invention;

FIG. 9A is a flowchart of a processing flow in the case where a processing of plural command data succeeds in an IC tag system of the third embodiment;

FIG. 9B is a flowchart of a processing flow in the case where a processing of plural command data ends in failure in the IC tag system of the third embodiment;

FIG. 10 is a block diagram of an IC tag according to a fourth embodiment of the present invention;

FIG. 11A is a flowchart of a processing flow for a TAG 1 in the IC tag system of the fourth embodiment;

FIG. 11B is a flowchart of a processing flow for a TAG 2 in the IC tag system of the fourth embodiment;

FIG. 12 is a graph showing a relation between a distance between a reader/writer and an IC tag and a communication success rate;

FIG. 13 is a flowchart of a processing flow in the case where a processing of plural command data succeeds in a conventional IC tag system; and

FIG. 14 is a flowchart of a processing flow in the case where a processing of plural command data ends in failure in the conventional IC tag system.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

To begin with, an IC tag system 100 according to a first embodiment of the present invention is described. FIG. 1 is a block diagram of the IC tag system 100 of the first embodiment. As shown in FIG. 1, the IC tag system 100 of the first embodiment includes a reader/writer 200 and an IC tag 300. The IC tag system 100 is a communication system where the reader/writer 200 and the IC tag 300 communicate with each other by radio via a predetermined communication protocol.

The reader/writer 200 is communicably connected with a computer (not shown), for example. The reader/writer writes predetermined data to a storage circuit in the IC tag 300 or reads written data from the IC tag 300 in accordance with an instruction from the computer.

At the time of writing/reading data to/from the IC tag 300, for example, if the reader/writer 200 and the IC tag 300 get close to each other, the IC tag 300 receives radio waves from the reader/writer 200 to rectify the radio waves to generate a power supply voltage VDD. The reader/writer 200 sends a command from the computer to the IC tag 300, and the IC tag 300 receives the command to write/read data to/from the storage circuit in the IC tag 300 storage circuit.

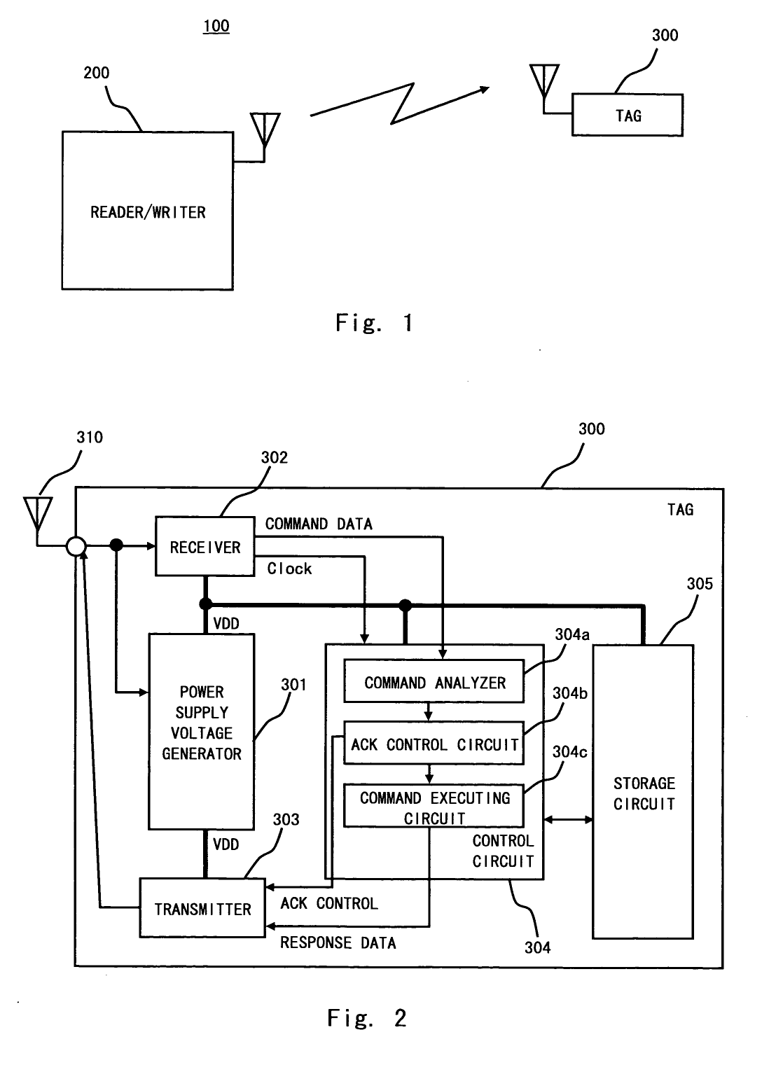

FIG. 2 is a block diagram of the IC tag 300. Referring to FIG. 2, the IC tag 300 is described. The IC tag 300 includes an antenna 310. The IC tag transmits/receives a radio signal to/from the reader/writer 200 through the antenna 310. The antenna 310 has characteristics suitable for characteristics of the radio signal. Further, the IC tag 300 includes a power supply voltage generator 301, a receiver 302, a transmitter 303, a control circuit 304, and a storage circuit 305, which are formed on a chip of a semiconductor substrate, for example. That is, the IC tag 300 is completed by integrating the antenna 310 and the chip.

The power supply voltage generator 301 generates the power supply voltage VDD based on amplitude of the radio signal received through the antenna 310 to supply power to each block in the IC tag 300. The receiver 302 generates clocks and command data used in the IC tag 300 based on the radio signal received through the antenna 310. The clock is generated based on a frame pulse period. The clock is input to the control circuit 304 and serves as a reference clock for operating the control circuit 304. The frame pulse and the command data are described in detail below.

The transmitter 303 is a block generating a radio signal to be sent through the antenna 310 from the IC tag 300 to the reader/writer 200. The radio signal sent from the transmitter 303 is generated based on an ACK control signal from the control circuit 304 or a response data signal. In addition, the radio signal generated with the transmitter 303 is superimposed on a carrier reflected by the antenna 310 and transmitted to the reader/writer 200.

The control circuit 304 includes a command analyzer 304a, an ACK control circuit 304b, and a command executing circuit 304c. The command analyzer 304a analyzes the check sum (chkSUM) of command data input from the receiver 302 to determine whether or not the received command data is correct, for example. The ACK control circuit 304b outputs an ACK control signal to the transmitter 303 if the check sum result from the command analyzer 304a shows that the command data is correct. Further, the ACK control circuit 304b sends the command data from the command analyzer 304a to the command executing circuit 304c. The command executing circuit 304c is a block executing a command and controlling the IC tag 300 based on command data. Here, the check sum is calculated through confirmation about whether or not an error occurs in the command data. Regarding the confirmation, if the sum of numerical values of the command data from the reader/writer equals the sum of numerical values of the received command data as a result of comparison, the command data is determined as normal command data that involves neither bit loss nor an error such as data reception error.

The storage circuit 305 is a block storing identification information (ID) about the IC tag 300, set data such as a state flag representing an IC tag state, or product data sent from the reader/writer 200. Further, data is written to/read from the storage circuit 305 in accordance with an instruction from the control circuit 304. Incidentally, the state flag representing the IC tag state may be stored in a register other than the storage circuit 305.

The IC tag system 100 of the first embodiment execute communications such that the reader/writer 200 sends command data to the IC tag 300, and the IC tag 300 sends response data back to the reader/writer 200. The command data to be sent includes first command data (for example, passive command data) not requiring the IC tag 300 to send the response data back to the reader/writer and second command data (for example, active command data) requiring the IC tag 300 to send the response data back to the reader/writer. Examples of the response data include information stored in the storage circuit 305 of the IC tag 300 (for example, identification information, a state flag, product data, and the like). The response data is sent from the IC tag 300 to the reader/writer 200.

The active command data is a Read command to read information stored in the storage circuit 305 of the IC tag 300, for example. Further, the passive command data is an INIT command to initialize the IC tag 300, a Wake command to switch the IC tag 300 from a nonoperating state (Sleep state) to an operating state (Wake state), or an ADR_SET command to designate an address of the storage circuit 305, for example.

The IC tag system 100 controls the IC tag 300 based on the passive command data and reads information stored in the storage circuit 305 of the IC tag 300 based on the active command data. That is, the IC tag 300 can complete a series of operations using the passive command data and the active command data in combination.

The command data is generated by appropriately combining “data 1” and “data 0” which are defined based on a relation between a frame pulse and its subsequent pulses. Here, the data 1 represents a digital signal of “1” and the data 0 represents a digital signal of “0”, for example.

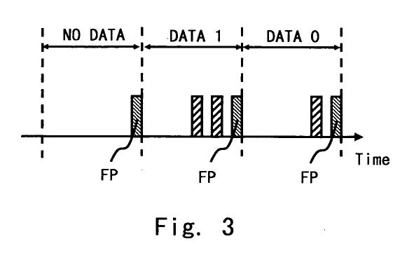

The frame pulse and the command data sent from the reader/writer 200 to the IC tag 300 are described in detail below. First, how to express the command and “data 1” and “data 0” in the command data is described. In this embodiment, “no data”, “data 1”, and “data 0” are expressed based on a pulse train as shown in FIG. 3. The frame pulses (FP) are transmitted from the reader/writer at a pulse frequency of, for example, 20 kHz, and used as a synchronous signal between the reader/writer 200 and the IC tag 300. If there are no other pulses before the frame pulse, “no data” is set. If the frame pulse follows two consecutive pulses, “data 1” is set. If the frame pulse follows one pulse, “data 0” is set.

Incidentally, in this embodiment, the command data is transmitted using the aforementioned frame pulse and data, but a signal used for transmitting the command data is not limited to the above signal.

Receiving the passive command data, the IC tag 300 of the first embodiment executes the check sum of the command data with an internal circuit of the IC tag 300. If the check sum result shows that the command data is correctly received, the IC tag 300 sends a confirmation signal (for example, ACK (ACKnowledge)) to the reader/writer 200 and then executes the received command. Here, the ACK is a signal for notifying the reader/writer 200 that the IC tag succeeds in receiving the command data. The ACK does not include information stored in the storage circuit 305 like the response data. The ACK is a signal for notifying the reader/writer 200 that the IC tag succeeds in receiving the command data, by use of one pulse.

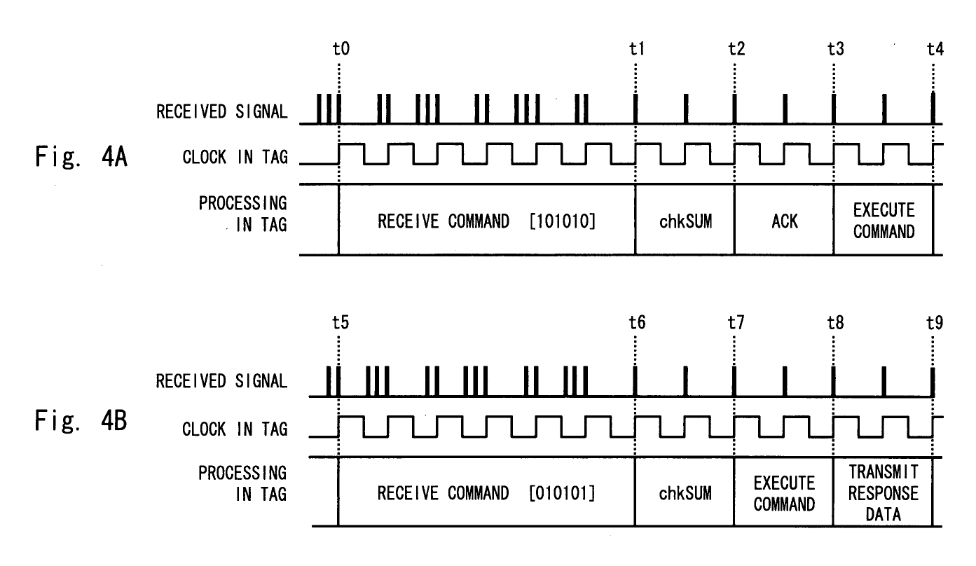

An operation of the IC tag 300 that receives the passive command data is described. Here, the operation of the IC tag 300 is described taking the case of receiving one passive command data as an example. FIG. 4A is a timing chart of received signals in this case, clocks in a tag, which are generated from the received signal, and a processing in the tag.

As shown in FIG. 4A, during a period from time t0 to time t1, the IC tag 300 generates a clock from a frame pulse of the received signal, and receives command data based on the number of pulses that are input prior to the frame pulse. Upon the completion of receiving the command data at time t1, during a period from time t1 to time t4, the IC tag 300 executes the check sum of a command, transmits the ACK, and executes a command. Here, in a period from time t1 to time t4 as well, the frame pulse is transmitted from the reader/writer 200 to the IC tag 300, and the IC tag 300 generates a clock used therein based on the frame pulse and operates based on the clock.

To describe an operation of the IC tag 300 during the period from time t1 to time t4, the IC tag 300 executes the check sum at time t1 to time t2, for example. If the check sum result shows that the command data is correctly received, at time t2 to time t3, the IC tag 300 transmits the ACK to the reader/writer 200. After that, at time t3 to time t4, IC tag 300 executes a command and operates in accordance with the command.

Further, when receiving the active command data, the IC tag 300 of the first embodiment executes the check sum of the command data with an internal circuit of the IC tag 300. If the check sum result shows that the command data is correctly received, the IC tag executes the received command and transmits response data to the reader/writer 200.

The operation of the IC tag 300 that receives active command data is described. Here, the operation of the IC tag 300 is described taking the case of receiving one active command data as an example. FIG. 4B is a timing chart of received signals in this case, clocks in a tag, which are generated from the received signal, and a processing in the tag.

As shown in FIG. 4B, during a period from time t5 to time t6, the IC tag 300 generates a clock from a frame pulse of the received signal, and receives command data based on the number of pulses that are input prior to the frame pulse. Upon the completion of receiving the command data at time t6, during a period from time t6 to time t9, the IC tag 300 executes the check sum of a command, executes a command, and sends response data.

To describe an operation of the IC tag 300 during the period from time t6 to time t9, the IC tag 300 executes the check sum at time t6 to time t7, for example. If the check sum result shows that the command data is correctly received, at time t7 to time t8, the IC tag 300 executes a command and operates in accordance with the command. After that, at time t8 to time t9, the IC tag sends response data to the reader/writer 200.

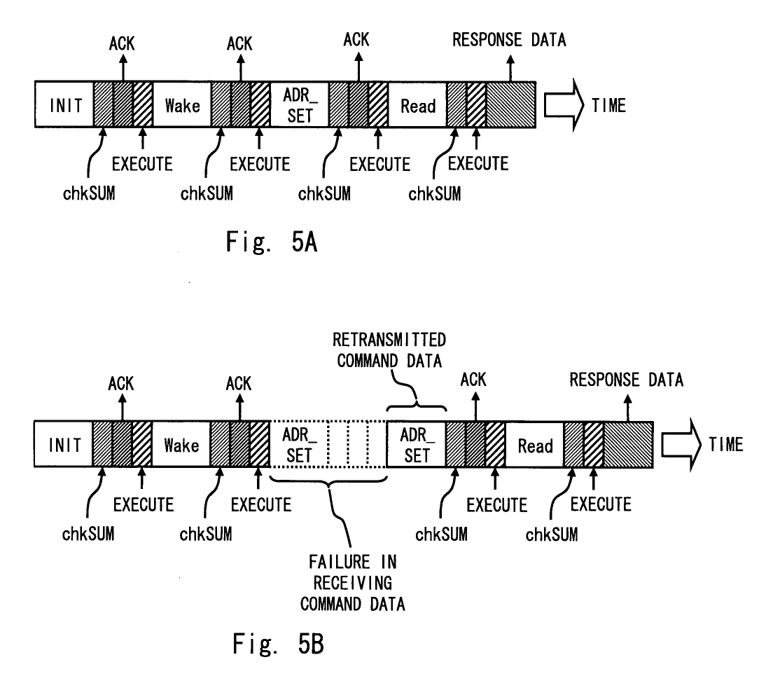

Description is given of an example in which a series of operations are executed using the passive command data and the active command data in combination in the IC tag system 100. Here, the operation (communication) from the initialization of the IC tag 300 to a reading operation of the first ID address upon the ID verification of the IC tag 300 is described by way of example. FIG. 5A shows a processing flow in the case where all command data are correctly received.

As shown in FIG. 5A, if receiving the INIT command, the IC tag 300 first executes the check sum of command data. If the check sum result is correct, the ACK is sent to the reader/writer 200. After that, the INIT command is executed to initialize the IC tag 300. Following the INIT command, the Wake command, and the ADR_SET command are sent from the reader/writer 200 to the IC tag 300. When the IC tag 300 receives commands, the IC tag 300 executes the check sum, transmits the ACK, and executes a command similar to the INIT command.

Subsequently, if the Read command is sent from the reader/writer 200 to the IC tag 300, the IC tag 300 executes the check sum of the command data. After that, the IC tag 300 executes a command, and sends information about an address designated by the ADR_SET command, to the reader/writer 200 as response data.

On the other hand, in a series of command data communications, if the IC tag 300 fails in receiving predetermined command data, the reader/writer 200 retransmits the command data that the IC tag 300 failed in receiving, and then transmits subsequent command data. At this time, if the ACK is not sent back from the IC tag 300 for the transmitted command data even after the elapse of a predetermined period, the reader/writer 200 concludes that the IC tag 300 failed in receiving the command data.

Description is given of the case where the IC tag 300 fails in receiving the ADR_SET command as an example. FIG. 5B shows a processing flow in the case where the IC tag 300 fails in receiving the ADR_SET command.

As shown in FIG. 5B, if the INIT command and the Wake command are correctly received, after the reception of the command data, the ACK is sent from the IC tag 300 to the reader/writer 200. Next, if the IC tag fails in receiving the ADR_SET command, the IC tag 300 does no transmit the ACK to the reader/writer 200. The reader/writer 200 concludes that the IC tag 300 failed in receiving the ADR_SET command from the fact that the ACK is not sent back from the IC tag 300 after the elapse of a predetermined period from the command transmission. After that, the reader/writer 200 retransmits the ADR_SET command. If the IC tag 300 correctly receives the retransmitted ADR_SET command, the IC tag sends the ACK to the reader/writer 200.

After that, the Read command is sent from the reader/writer 200 to the IC tag 300, and if the IC tag 300 correctly receives the command, the IC tag 300 executes the check sum and the command, and sends the response data.

As understood from the above description, the IC tag system 100 of the first embodiment can determine whether or not the passive command data communication succeeds based on whether or not the IC tag 300 sends back the ACK to the passive command data transmitted from the reader/writer 200. Hence, the reader/writer 200 can retransmit the passive command which the IC tag 300 failed in receiving.

A conventional IC tag system 100 determines whether or not the communication succeeds based on the response data to the active command data. For this reason, the reader/writer 200 cannot detect which command data could not be received by the IC tag. Therefore, if no response data is sent from the IC tag 300, the reader/writer needs to retransmit a series of command data from the first one, which causes a problem in that it takes more time to retransmit the command data.

On the other hand, in the IC tag system 100 of the first embodiment, the reader/writer 200 can detect passive command data which the IC tag 300 failed in receiving, and retransmit the passive command data. That is, even if the IC tag 300 fails in receiving command data, the reader/writer 200 can retransmit the command data which the IC tag 300 failed in receiving, and continuously transmit subsequent command data. Therefore, the IC tag system 100 of the first embodiment can shorten a period necessary for retransmitting the command data.

### Second Embodiment

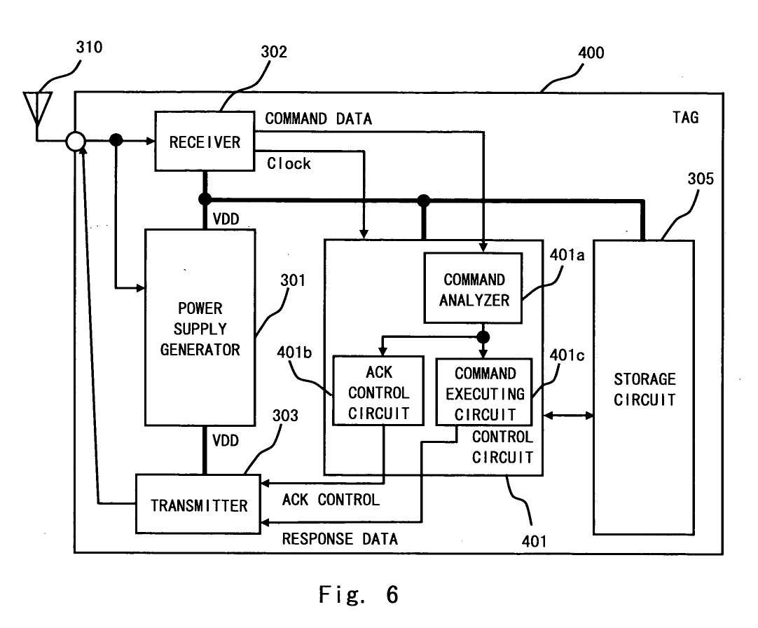

FIG. 6 is a block diagram of an IC tag 400 according to a second embodiment of the present invention. Here, blocks of the IC tag 400 of the second embodiment which carry out the same operations as those of the IC tag 300 of the first embodiment are denoted by identical reference numerals, and description thereof is omitted here.

A control circuit 401 of the IC tag 400 includes a command analyzer 401a, an ACK control circuit 401b, and a command executing circuit 401c. The command analyzer 401a analyzes the check sum (chkSUM) of command data input from the receiver 302 to determine whether or not the received command data is correct. If the check sum result of the command analyzer 401a shows that the command data is correct, the ACK control circuit 401b outputs an ACK control signal to the transmitter 303. The command executing circuit 401c is a block that executes a command and controls each block of the IC tag 400 based on the command data.

The IC tag system of the second embodiment differs from the IC tag system 100 of the first embodiment in that the IC tag 400 as shown in FIG. 6 replaces the IC tag 300 of FIG. 1. Although the IC tag 300 of the first embodiment executes the check sum, transmits the ACK, and executes a command after receiving the command data, the IC tag 400 of the second embodiment executes the check sum after receiving the command data and then simultaneously carries out the ACK transmission and the command execution.

Here, the IC tag 400 of the second embodiment executes a command by means of the command executing circuit 401c in the control circuit 401. Regarding the ACK transmission, the IC tag instructs the transmitter 303 to transmit the ACK using the ACK control signal output from the ACK control circuit 401b. That is, the command execution and the ACK transmission are carried out by different blocks and thus can be simultaneously performed.

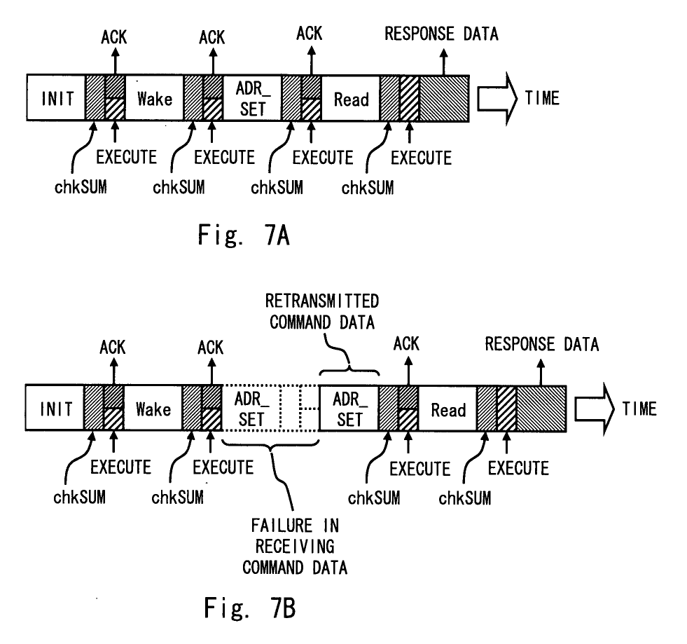

FIG. 7A shows a command data processing flow of the IC tag system of the second embodiment. As shown in FIG. 7A, the IC tag system of the second embodiment executes the check sum for the passive command data after receiving the command data, and then simultaneously carries out the ACK transmission and the command execution. Further, after the reception of the active command data, the check sum is executed and the command is executed, and then the response data is sent from the IC tag 400 to the reader/writer 200 as in the first embodiment.

On the other hand, in the IC tag system of the second embodiment, if the IC tag 400 fails in receiving the command data, the IC tag 400 transmits no ACK as in the first embodiment. The reader/writer 200 retransmits the command data which the IC tag failed in receiving, based on the fact that no ACK is sent back. FIG. 7B shows a processing flow thereof.

As understood from the above description, although in the first embodiment, it takes some time to transmit the ACK, the IC tag 400 simultaneously carries out the ACK transmission and the command execution in the IC tag system of the second embodiment, making it unnecessary to take the additional time to transmit the ACK. Thus, the command data processing period can be shorter than that of the IC tag system 100 of the first embodiment.

Further, since the IC tag 400 of the second embodiment transmits the ACK when receiving the passive command data, as in the first embodiment, even if the IC tag 400 fails in receiving the command data, a period necessary for retransmitting the command data can be reduced.

### Third Embodiment

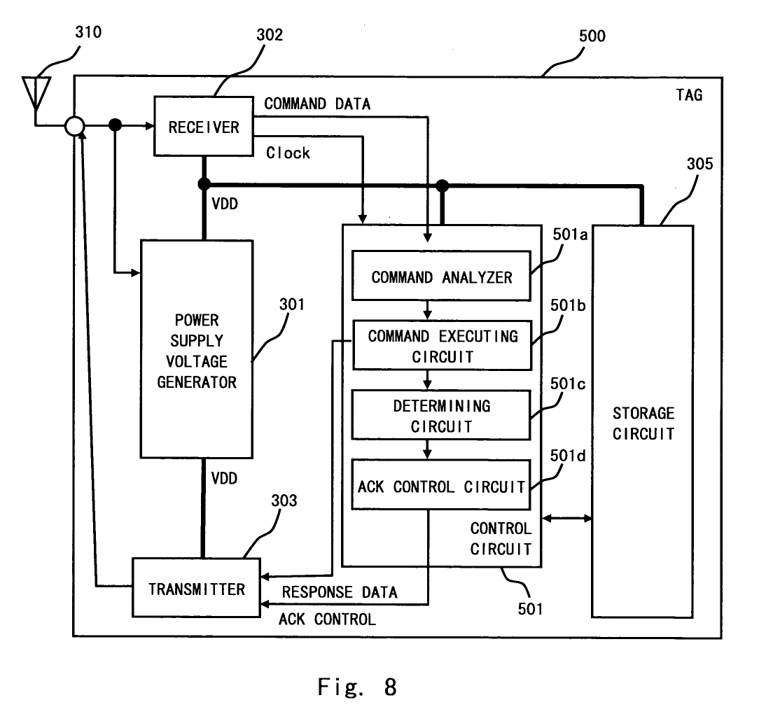

FIG. 8 is a block diagram of an IC tag 500 according to a third embodiment of the present invention. Here, blocks of the IC tag 500 of the third embodiment which perform the same operations as those of the IC tag 300 of the first embodiment are denoted by identical reference numerals, and description thereof is omitted here.

A control circuit 501 of the IC tag 500 includes a command analyzer 501a, a command executing circuit 501b, a determining circuit 501c, and an ACK control circuit 501d. The command analyzer 501a analyzes the check sum (chkSUM) of command data input from the receiver 302 to determine whether or not the received command data is correct. The command executing circuit 501b is a block that executes a command and controls each block of the IC tag 500 based on the command data. The determining circuit 501c is a block that determines whether or not the command executing circuit 501b correctly executes a command. If the determination result of the determining circuit 501c shows that the command executing circuit 501b correctly executes a command, the ACK control circuit 501d outputs an ACK control signal to the transmitter 303.

The IC tag system of the third embodiment differs from the IC tag system 100 of the first embodiment in that the IC tag 500 as shown in FIG. 8 replaces the IC tag 300 of FIG. 1. Although in the IC tag system 100 of the first embodiment, the IC tag 300 executes the check sum, transmits the ACK, and executes a command after receiving the command data, in the IC tag system of the third embodiment, the IC tag 500 executes the check sum after receiving the command data and subsequently executes the command to analyze the command execution result, and then transmits the ACK.

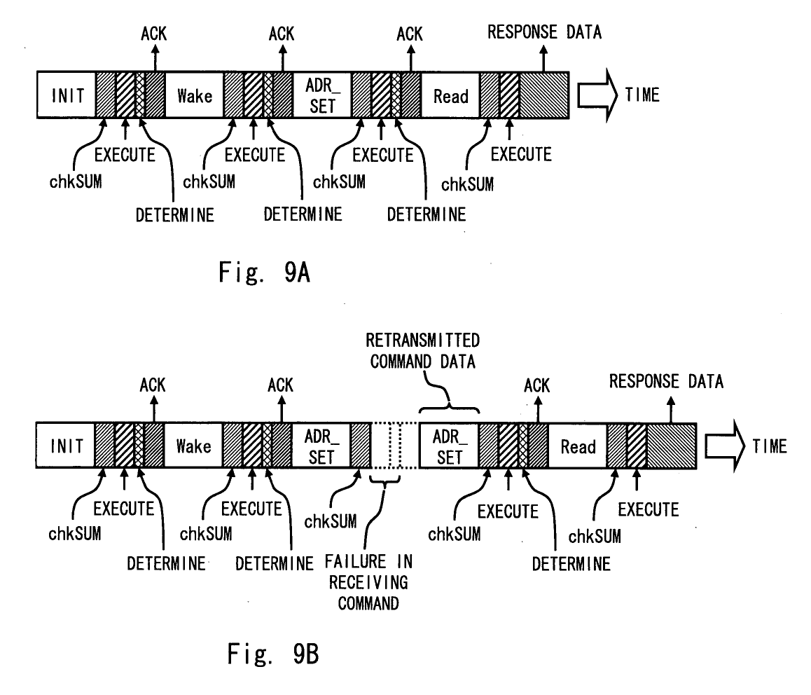

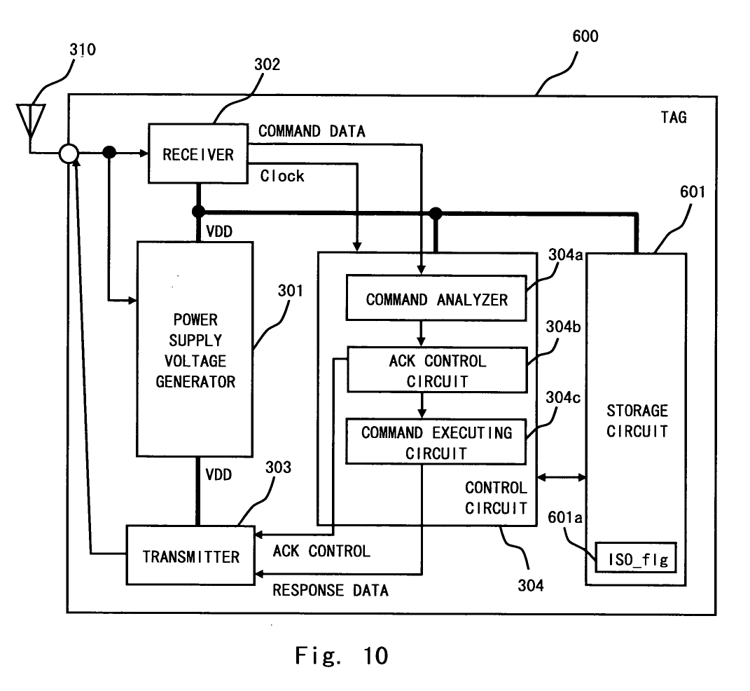

FIG. 9A shows a command data processing flow of the IC tag system of the third embodiment. As shown in FIG. 9A, the IC tag 500 of the third embodiment executes the check sum after receiving the passive command data and subsequently executes a command to analyze the command execution result, and then transmits the ACK. In addition, after receiving the active command data, the IC tag 500 executes the check sum and the command and then transmits response data to the reader/writer 200 as in the first embodiment.

On the other hand, in the IC tag system of the third embodiment, if the IC tag 500 succeeds in receiving the command data but fails in executing the command thereafter, the IC tag 500 transmits no ACK as in the first embodiment. The reader/writer 200 retransmits the command data which the IC tag failed in receiving, based on the fact that no ACK is sent back. FIG. 9B shows a processing flow thereof. Incidentally, also in the IC tag 500 of the third embodiment, if the IC tag fails in receiving the command data, the ACK is not transmitted as in the IC tag 300 of the first embodiment.

As understood from the above description, in the IC tag system of the third embodiment, the ACK is transmitted based on the command execution result. Thus, it is possible to determine whether or not the command data communication succeeds based on not only whether or not the command data is successfully received but also the command execution result. That is, in the IC tag system of the third embodiment, subsequent command data can be transmitted only after it is confirmed that the command data communication and the command execution succeed. Accordingly, the IC tag system of the third embodiment can carry out the command data communication and the command execution more reliably than the IC tag system 100 of the first embodiment.

Further, the IC tag 500 of the third embodiment transmits the ACK after determining that the command data is successfully executed. That is, the IC tag 500 of the third embodiment enables more reliable communications than the IC tag of the first embodiment although a period necessary for receiving the command data is increased due to the determination as to whether or not the command data is successfully executed.

### Fourth Embodiment

In the IC tag system, during a period in which the reader/writer communicates with one IC tag within a radio signal receivable area, if an IC tag unidentified by the reader/writer enters the radio signal receivable area, the unidentified IC tag sends back the ACK or response data to the command data from the reader/writer. In such case, there is a possibility that if the identified IC tag fails in receiving the command data and cannot send back the ACK or response data, the reader/writer determines that the command data communication is correctly executed, by mistake due to the ACK or response data from the unidentified IC tag.

To that end, an IC tag 600 according to a fourth embodiment of the present invention includes a flag for checking its own state, and determines whether or not to send back the ACK or response data based on the flag.

FIG. 10 shows the IC tag 600 of the fourth embodiment. As shown in FIG. 10, the IC tag 600 is completed by adding a flag storing the IC tag state to the storage circuit 305 of the IC tag 300 of the first embodiment. The IC tag 600 of the fourth embodiment controls the ACK transmission based on the flag storing the IC tag state (for example, sleep flag: Slp_flg). The Slp_flg is set to “0” when the IC tag 600 is in an operating state and to “1” when the IC tag 600 is in a nonoperating state. The Slp_flg is set to “1” at the power-on reset if an IC tag enters the radio signal receivable area as an area where the reader/writer 200 and the IC tag can exchange a radio signal. That is, the IC tag entering the radio signal receivable area does not send back the ACK or response data because of Slp_flg=“1”.

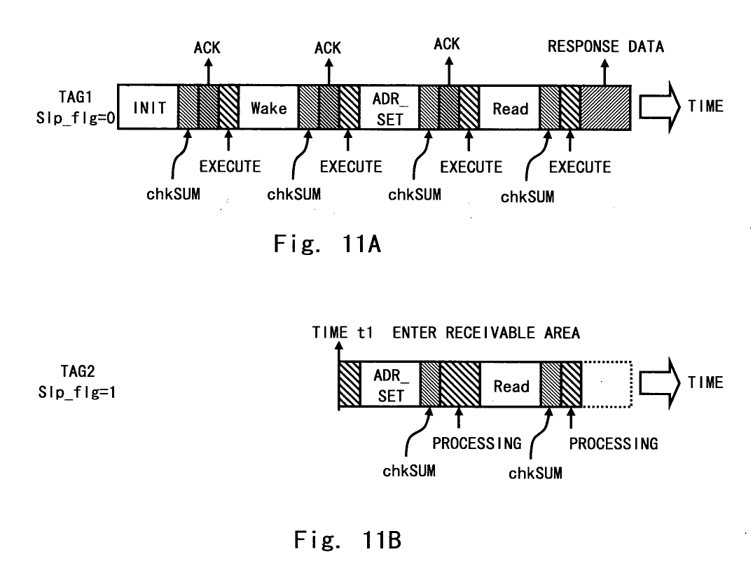

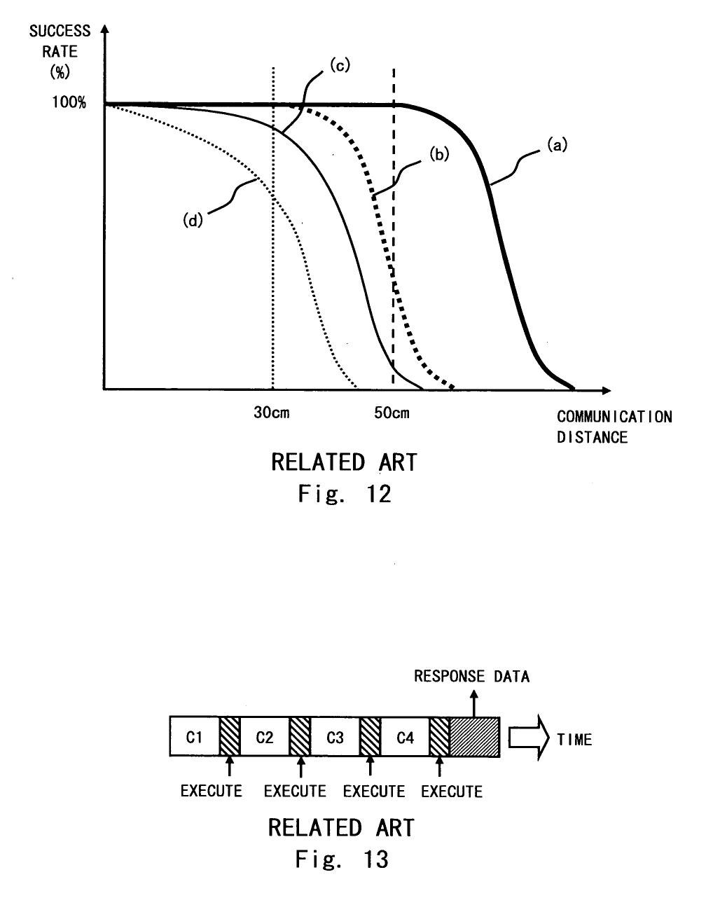

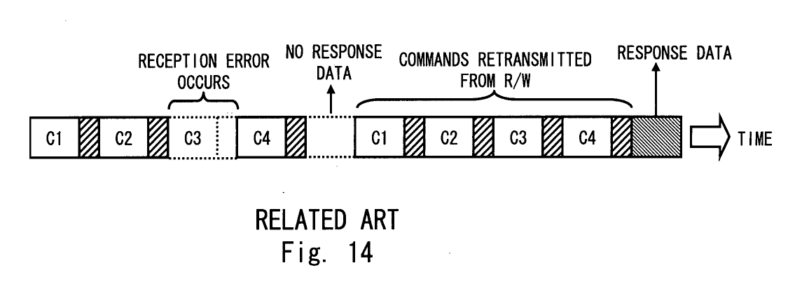

FIGS. 11A and 11B show a difference in response of the IC tag depending on the value of Slp_flg. Here, the IC tag under the condition that Slp_flg=“0” is defined as TAG 1, and the IC tag under the condition that Slp_flg=“1” is defined as TAG 2. FIG. 11A shows a command data processing flow of the TAG 1, and FIG. 11B shows a command data processing flow of the TAG 2.

As shown in FIG. 11A, an ID of the TAG 1 is unidentified by the reader/writer 200 and therefore, the TAG 1 receives the INIT command to the Read command to send the ACK and response data in accordance with each command data. Thus, the TAG 1 sends a unique ID to the reader/writer 200.

On the other hand, as shown in FIG. 11B, if the TAG 2 enters the radio signal receivable area of the reader/writer 200 at time t1, the Slp_flg is switched to “1” due to the power-on reset, the TAG 2 does not transmit the ACK or response data for the command data from the reader/writer 200. At this time, the TAG 2 receives the command data but disables the received command data.

As understood from the above description, the IC tag 600 of the fourth embodiment transmits the ACK or response data based on the value of the flag. Therefore, the reader/writer 200 can receive the ACK or response data only from the IC tag intended to send back a response to the transmitted command data.

The IC tag system needs to identify each of plural IC tags within the radio signal receivable area of the reader/writer 200 to separately process the IC tags. In this case, if all the IC tags send back the ACK or response data to all commands, there arises a problem in that the reader/writer 200 confuses between the IC tags.

To that end, the IC tag 600 determines whether or not to transmit the ACK or response data based on a value of the flag representing the IC tag state, thereby avoiding such a situation that the ACK or response data is sent back irrespective of the IC tag state. Hence, the reader/writer 200 never confuses between the IC tags.

Incidentally, as another embodiment of the present invention, the definition of the radio signal used in data communications is not limited to the aforementioned definition that the data 1 and the data 0 are determined based on the number of pulses. Instead, the data 1 and the data 0 maybe defined based on the pulse width.

It is apparent that the present invention is not limited to the above embodiment that may be modified and changed without departing from the scope and spirit of the invention.

What is claimed is:

1. An IC tag for receiving a command data including a first command data not requiring the IC tag to send back response data and a second command data requiring the IC tag to send back the response data using a radio signal, comprising:
a control circuit generating a confirmation signal indicating a reception condition of first command data; and
a transmitter transmitting the confirmation signal.

2. The IC tag according to claim 1, wherein if receiving the second command data, the IC tag does not transmit the confirmation signal.

3. The IC tag according to claim 1, wherein the control circuit comprising an ACK control circuit notifying the transmitter of the reception condition of the first command data.

4. The IC tag according to claim 1, wherein the IC tag receives the first command data and the second command data to execute commands based on the first command data and the second command data to complete transmission of the response data.

5. The IC tag according to claim 1, wherein the transmission of the confirmation signal and the transmission of the response data are carried out based on a flag indicating a state of the IC tag and incorporated in the IC tag.

6. The IC tag according to claim 1, wherein the confirmation signal is transmitted if a command analyzer incorporated in the control circuit confirms that an error does not occur in command data.

7. The IC tag according to claim 1, wherein the confirmation signal is transmitted during a period from completion of confirming whether or not the error occurs until the IC tag starts executing a command of the first command data.

8. The IC tag according to claim 1, wherein the confirmation signal is transmitted during a period in which the IC tag executes a command of the first command data after completion of confirming whether or not the error occurs.

9. The IC tag according to claim 1, wherein the confirmation signal is transmitted after the confirmation about whether or not the error occurs is completed, the IC tag executes a command of the first command data, and it is determined that the first command data is correctly executed.

10. An IC tag system, comprising:
a reader/writer transmitting command data; and
an IC tag receiving the command data from the reader/writer,
the command data including first command data not requiring the IC tag to send response data back to the reader/writer and second command data requiring the IC tag to send the response data back to the reader/writer, and
the IC tag notifying the reader/writer that the first command data is received if receiving the first command data from the reader/writer.

11. The IC tag system according to claim 10, wherein if receiving the second command data, the IC tag does not notify the reader/writer of a reception condition.

12. The IC tag system according to claim 10, wherein the IC tag comprising:
an ACK control circuit notifying a transmitter of a reception condition of the first command data.

13. The IC tag system according to claim 10, wherein the IC tag receives the first command data and the second command data to execute commands based on the first command data and the second command data to complete transmission of the response data.

14. The IC tag system according to claim 10, wherein a notification that the first command data is received and the response data are sent based on a flag indicating a state of the IC tag and incorporated in the IC tag.

15. The IC tag system according to claim 10, wherein a notification that the first command data is received is sent if a command analyzer incorporated in the IC tag confirms that an error does not occur in command data.

16. The IC tag system according to claim 10, wherein a notification that the first command data is received is sent during a period from completion of confirming whether or not the error occurs until the IC tag starts executing a command of the first command data.

17. The IC tag system according to claim 10, wherein a notification that the first command data is received is sent during a period in which the IC tag executes a command of the first command data after completion of confirming whether or not the error occurs.

18. The IC tag system according to claim 10, wherein a notification that the first command data is received is sent after the confirmation about whether or not the error occurs is completed, the IC tag executes a command of the first command data, and it is determined that the first command data is correctly executed.

19. A data communicating method for an IC tag that receives a command data including a first command data not requiring the IC tag to send back response data and a second command data requiring the IC tag to send back the response data using a radio signal, comprising:
receiving the first command,
analyzing a reception condition of the first command data, and
transmitting the confirmation signal based on the reception condition.
